(19) United States
(12) Patent Application Publication
(10) Pub. No.: US 2025/0328488 A1
(43) Pub. Date: Oct. 23, 2025

(54) SEMICONDUCTOR DEVICE

(71) Applicant: TAIWAN SEMICONDUCTOR MANUFACTURING COMPANY, LTD., Hsinchu (TW)

(72) Inventors: Brian CRAFTON, San Jose, CA (US); Xiaoyu SUN, San Jose, CA (US)

(73) Assignee: TAIWAN SEMICONDUCTOR MANUFACTURING COMPANY, LTD., Hsinchu (TW)

(21) Appl. No.: 18/642,399

(22) Filed: Apr. 22, 2024

(51) Int. Cl. G06F 15/80

(52) U.S. Cl. CPC G06F 15/8046

(57) ABSTRACT

A device includes a first register, a second register, a third register and a first logic element. The first register is configured to store first input data. The second register is configured to store first weight data. The third register is configured to output first output data according to each of the first input data and the first weight data. The first logic element is configured to control the first register according to each of first bit data and second bit data. The first bit data and the second bit data correspond to the first input data and the first weight data, respectively.

### BACKGROUND

Some semiconductor devices include systolic arrays to perform matrix multiplication by streaming input data to arrays of processing elements. Some input data contain a high number of O-valued elements. However, once the data is already in the input stream, operations of systolic arrays on each element of the data are performed, and the power consumption of the semiconductor device is high.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a schematic diagram of a processing element, in accordance with some embodiments of the present disclosure.

FIG. 1B is a schematic diagram of logic elements, in accordance with some embodiments of the present disclosure.

FIG. 2 is a schematic diagram of a systolic array, in accordance with some embodiments of the present disclosure.

FIG. 3 is a schematic diagram of a systolic array, in accordance with some embodiments of the present disclosure.

FIG. 4 is a flowchart diagram of a method operating at least one of the processing elements shown in FIG. 1A, FIG. 2 and FIG. 3, in accordance with some embodiments of the present disclosure.

FIG. 5 is a flowchart diagram of a method operating at least one of the processing elements shown in FIG. 1A, FIG. 2 and FIG. 3, in accordance with some embodiments of the present disclosure.

FIG. 6 is a flowchart diagram of a method operating at least one of the processing elements shown in FIG. 1A, FIG. 2 and FIG. 3, in accordance with some embodiments of the present disclosure.

### DETAILED DESCRIPTION

The following disclosure provides many different embodiments, or examples, for implementing different features of the provided subject matter. Specific examples of components, materials, values, steps, arrangements or the like are described below to simplify the present disclosure. These are, of course, merely examples and are not intended to be limiting. Other components, materials, values, steps, arrangements or the like are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly. As used herein, “around,” “about,” “approximately,” or “substantially” may generally mean within 20 percent, or within 10 percent, or within 5 percent of a given value or range. Numerical quantities given herein are approximate, meaning that the term “around,” “about,” “approximately,” or “substantially” can be inferred if not expressly stated. One skilled in the art will realize, however, that the values or ranges recited throughout the description are merely examples, and may be reduced or varied with the down-scaling of the integrated circuits.

The terms applied throughout the following descriptions and claims generally have their ordinary meanings clearly established in the art or in the specific context where each term is used. Those of ordinary skill in the art will appreciate that a component or process may be referred to by different names. Numerous different embodiments detailed in this specification are illustrative only, and in no way limits the scope and spirit of the disclosure or of any exemplified term.

It is worth noting that the terms such as “first” and “second” used herein to describe various elements or processes aim to distinguish one element or process from another. However, the elements, processes and the sequences thereof should not be limited by these terms. For example, a first element could be termed as a second element, and a second element could be similarly termed as a first element without departing from the scope of the present disclosure.

In the following discussion and in the claims, the terms “comprising,” “including,” “containing,” “having,” “involving,” and the like are to be understood to be open-ended, that is, to be construed as including but not limited to. As used herein, instead of being mutually exclusive, the term “and/or” includes any of the associated listed items and all combinations of one or more of the associated listed items.

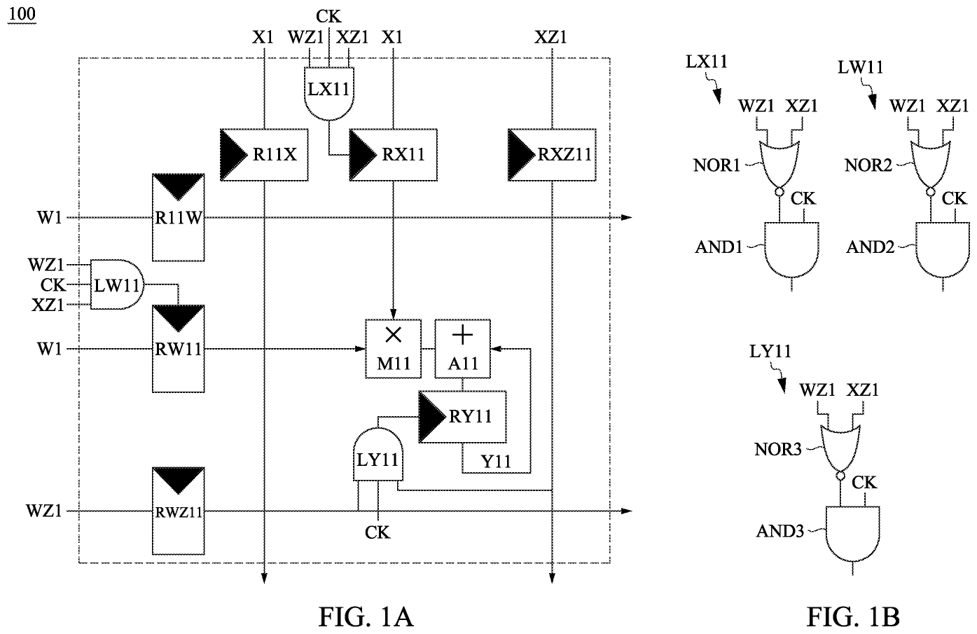

FIG. 1A is a schematic diagram of a processing element 100, in accordance with some embodiments of the present disclosure. As illustratively shown in FIG. 1A, the processing element 100 includes registers R11X, R11W, RX11, RW11, RXZ11, RWZ11 and RY11, logic elements LX11, LW11 and LY11, a multiplier M11 and an adder A11. In some embodiments, the register R11X is referred to as an input X register. The register R11W is referred to as an input W register. The register RX11 is referred to as a clock-gated X register. The register RW11 is referred to as a clock-gated W register. The register RXZ11 is referred to as an X-zero register. The register RWZ11 is referred to as a W-zero register. The register RY11 is referred to as an accumulation register or a clock-gated Y register. The combination of the multiplier M11 and the adder A11 is referred to as an MAC (multiply accumulate) unit.

In some embodiments, the register R11X is configured to store input data X1 and output the input data X1 according to a clock signal CK. The register R11W is configured to store weight data W1 and output the weight data W1 according to the clock signal CK. The register RX11 is configured to store the input data X1 and output the input data X1 to a multiplier M11 according to each of bit data XZ1, WZ1 and the clock signal CK. The register RW11 is configured to store the weight data W1 and output the weight data W1 to the multiplier M11 according to each of the bit data XZ1, WZ1 and the clock signal CK. The register RXZ11 is configured to store the bit data XZ1 and output the bit data XZ1 according to the clock signal CK. The register RWZ11 is configured to store the bit data WZ1 and output the bit data WZ1 according to the clock signal CK. The register RY11 is configured to store each of output data Y11 and AD11 from the adder A11 and output each of the output data Y11 and AD11 to the adder A11 according to each of the bit data XZ1, WZ1 and the clock signal CK.

In some embodiments, the logic element LX11 is configured to receive each of the bit data XZ1, WZ1 and the clock signal CK and control the register RX11 to output the input data X1 to the multiplier M11 according to each of the bit data XZ1, WZ1 and the clock signal CK. The logic element LW11 is configured to receive each of the bit data XZ1, WZ1 and the clock signal CK and control the register RW11 to output the weight data W1 to the multiplier M11 according to each of the bit data XZ1, WZ1 and the clock signal CK. The logic element LY11 is configured to receive each of the bit data XZ1, WZ1 and the clock signal CK and control the register RX11 to output the output data Y11 to the adder A11 according to each of the bit data XZ1, WZ1 and the clock signal CK.

In some embodiments, the multiplier M11 is configured to receive each of the input data X1 and the weight data W1, multiply the input data X1 and the weight data W1 to generate output data MD11 and output the output data MD11 to the adder A11. The adder A11 is configured to receive each of the output data MD11 and Y11, add the output data MD11 and Y11 to generate output data AD11 and output the output data AD11 to the register RY11.

In some embodiments, each of the input data X1 and the weight data W1 is multiple-bit data, such as 32-bit data. In some embodiments, each of the input data X1 and the weight data W1 is data other than 32-bit data. In some embodiments, each of the bit data XZ1 and the bit data WZ1 is 1-bit data. In some embodiments, each of the bit data XZ1 and the bit data WZ1 is data other than 1-bit data. In some embodiments, the bit data XZ1 and the bit data WZ1 represent zero flags of the input data X1 and the weight data W1, respectively. Specifically, the bit data XZ1 indicates whether each of the bits of the input data X1 has a logic value 0, and the weight data W1 indicates whether each of the bits of the weight data W1 has a logic value 0. For example, in response to each of the bits of the input data X1 having the logic value 0, the bit data XZ1 has a logic value 1. In response to at least one of the bits of the input data X1 having the logic value 1, the bit data XZ1 has the logic value 0. In response to each of the bits of the weight data W1 having the logic value 0, the bit data WZ1 has the logic value 1. In response to at least one of the bits of the weight data W1 having the logic value 1, the bit data WZ1 has the logic value 0.

It is noted that when the input data X1 has data value equal to 0, each of the bits of the input data X1 has the logic value 0. When the input data X1 has the data value not equal to 0, at least one of the bits of the input data X1 has the logic value 1. When the weight data W1 has data value equal to 0, each of the bits of the weight data W1 has the logic value 0. When the weight data W1 has the data value not equal to 0, at least one of the bits of the weight data W1 has the logic value 1.

In some embodiments, the clock signal CK has multiple clock cycles including a first clock cycle and a second clock cycle, and each of the logic elements LX11 and LW11 is operated during the first clock cycle, and the logic element LY11 is operated during the second clock cycle.

In some embodiments, when at least one of the bit data XZ1 and WZ1 has the logic value 1, each of the registers RX11, RW11 and RY11 is clock gated and the data stored in the register RY11 does not update. Specifically, when at least one of the bit data XZ1 and WZ1 has the logic value 1, the logic elements LX11, LW11 and LY11 deactivate the registers RX11, RW11 and RY11, respectively.

For example, during the first clock cycle, in response to the bit data XZ1 having the logic value 1, the logic elements LX11, LW11 and LY11 deactivate the registers RX11, RW11 and RY11, respectively, such that each of the registers RX11, RW11 and RY11 is turned off. Accordingly, during the first clock cycle, the registers RX11 and RW11 do not output the input data X1 and the weight data W1 to the multiplier M11, respectively.

In such example, during the first clock cycle, the multiplier M11 is deactivated. Alternatively stated, the multiplier M11 does not operate the multiplication, does not generate the output data MD11 and does not output the output data MD11 to the adder A11. Then, during the second clock cycle, the register RY11 does not output the output data Y11 to the adder A11, the adder A11 does not operate the addition, does not generate the output data AD11 and output the output data AD11 to the register RY11. Therefore, the data stored in the register RY11 remains to be the output data Y11 and does not change.

For another example, during the first clock cycle, in response to the bit data WZ1 having the logic value 1, the logic elements LX11, LW11 and LY11 deactivate the registers RX11, RW11 and RY11, respectively, such that each of the registers RX11, RW11 and RY11 is turned off. Accordingly, during the first clock cycle, the registers RX11 and RW11 do not output the input data X1 and the weight data W1 to the multiplier M11, respectively.

In such example, during the first clock cycle, the multiplier M11 is deactivated. Alternatively stated, the multiplier M11 does not operate the multiplication, does not generate the output data MD11 and does not output the output data MD11 to the adder A11. Then, during the second clock cycle, the register RY11 does not output the output data Y11 to the adder A11, the adder A11 does not operate the addition, does not generate the output data AD11 and output the output data AD11 to the register RY11. Therefore, the data stored in the register RY11 remains to be the output data Y11 and does not change.

In some embodiments, when each of the bit data XZ1 and WZ1 has the logic value 0, each of the registers RX11, RW11 and RY11 is turned on and the data stored in the register RY11 updates. For example, when each of the bit data XZ1 and WZ1 has the logic value 0, the logic elements LX11, LW11 and LY11 activate the registers RX11, RW11 and RY11, respectively. Accordingly, during the first clock cycle, the registers RX11 and RW11 output the input data X1 and the weight data W1 to the multiplier M11, respectively. Then, the multiplier M11 multiplies the input data X1 and the weight data W1 to generate the output data MD11 and outputs the output data MD11 to the adder A11. Then, during the second clock cycle, the register RY11 does not output the output data Y11 to the adder A11, the adder A11 adds the output data MD11 and Y11 to generate the output data AD11 and output the output data AD11 to the register RY11. Therefore, the data stored in the register RY11 updates and changes from the output data Y11 to the output data AD11.

FIG. 1B is a schematic diagram of the logic elements LX11, LW11 and LY11 in FIG. 1A, in accordance with some embodiments of the present disclosure. As illustratively shown in FIG. 1B, the logic element LX11 includes a NOR gate NOR1 and an AND gate AND1. The logic element LW11 includes a NOR gate NOR2 and an AND gate AND2. The logic element LY11 includes a NOR gate NOR3 and an AND gate AND3.

In some embodiments, each of the logic elements LX11, LW11 and LY11 is implemented as a combination of a NOR gate and an AND gate. Specifically, in the logic element LX11, two input terminals of the NOR gate NOR1 are configured to receive the bit data XZ1 and WZ1, respectively. An input terminal of the AND gate AND1 is configured to receive the clock signal CK, and another input terminal of the AND gate AND1 is coupled to an output terminal of the NOR gate NOR1. An output terminal of the AND gate AND1 is coupled to the register RX11. In the logic element LW11, two input terminals of the NOR gate NOR2 are configured to receive the bit data XZ1 and WZ1, respectively. An input terminal of the AND gate AND2 is configured to receive the clock signal CK, and another input terminal of the AND gate AND2 is coupled to an output terminal of the NOR gate NOR2. An output terminal of the AND gate AND2 is coupled to the register RW11. In the logic element LY11, two input terminals of the NOR gate NOR3 are configured to receive the bit data XZ1 and WZ1, respectively. An input terminal of the AND gate AND3 is configured to receive the clock signal CK, and another input terminal of the AND gate AND3 is coupled to an output terminal of the NOR gate NOR3. An output terminal of the AND gate AND3 is coupled to the register RY11. In some embodiments, each of the logic elements LX11, LW11 and LY11 is implemented as logic elements other than a combination of a NOR gate and an AND gate which performs similar logic operations.

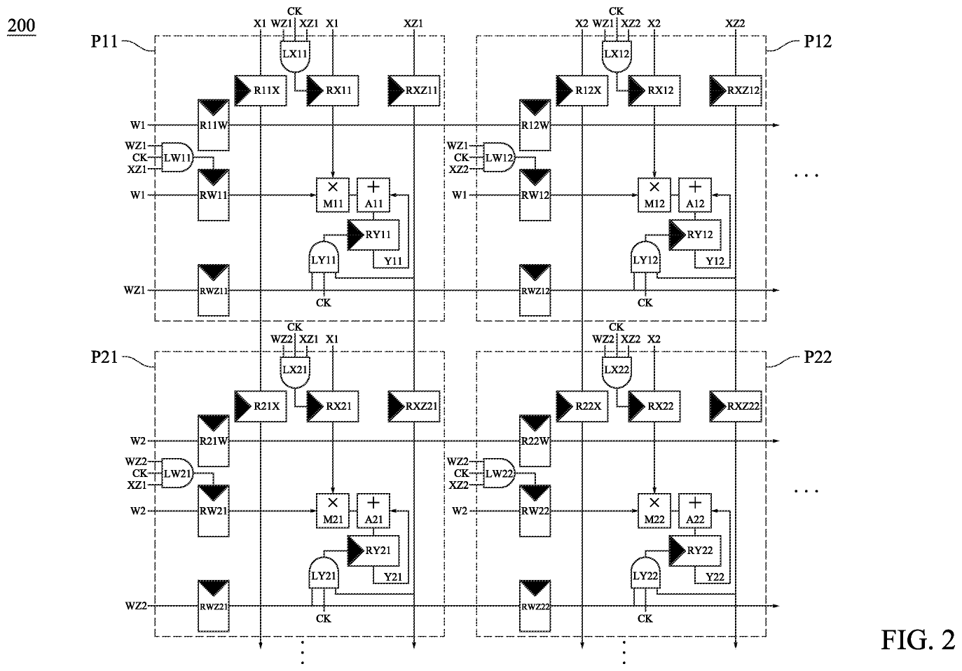

FIG. 2 is a schematic diagram of a systolic array 200, in accordance with some embodiments of the present disclosure. As illustratively shown in FIG. 2, the systolic array 200 includes at least processing elements P11, P12, P21 and P22. In some embodiments, the systolic array 200 includes processing elements other than processing elements P11, P12, P21 and P22. Referring to FIG. 2 and FIG. 1A, the processing element 100 is an embodiment of each of the processing elements P11, P12, P21 and P22 and other processing elements in the systolic array 200. FIG. 2 follows a similar labeling convention to that of FIG. 1A. In some embodiments, the processing element 100 in FIG. 1A is embedded in a systolic array, such as the systolic array 200 in FIG. 2.

As illustratively shown in FIG. 2, the processing element P11 includes the registers R11X, R11W, RX11, RW11, RXZ11, RWZ11 and RY11, the logic elements LX11, LW11 and LY11, the multiplier M11 and the adder A11. The processing element P12 includes registers R12X, R12W, RX12, RW12, RXZ12, RWZ12 and RY12, logic elements LX12, LW12 and LY12, a multiplier M12 and an adder A12. The processing element P21 includes registers R21X, R21W, RX21, RW21, RXZ21, RWZ21 and RY21, logic elements LX21, LW21 and LY21, a multiplier M21 and an adder A21. The processing element P22 includes registers R22X, R22W, RX22, RW22, RXZ22, RWZ22 and RY22, logic elements LX22, LW22 and LY22, a multiplier M22 and an adder A22.

In some embodiments, in the processing element P12, the register R12X is configured to store input data X2 and output the input data X2 according to a clock signal CK. The register R12W is configured to store weight data W1 and output the weight data W1 according to the clock signal CK. The register RX12 is configured to store the input data X2 and output the input data X2 to a multiplier M12 according to each of bit data XZ2, WZ1 and the clock signal CK. The register RW12 is configured to store the weight data W1 and output the weight data W1 to the multiplier M12 according to each of the bit data XZ2, WZ1 and the clock signal CK. The register RXZ12 is configured to store the bit data XZ2 and output the bit data XZ2 according to the clock signal CK. The register RWZ12 is configured to store the bit data WZ1 and output the bit data WZ1 according to the clock signal CK. The register RY12 is configured to store each of output data Y12 and AD12 from the adder A12 and output each of the output data Y12 and AD12 to the adder A12 according to each of the bit data XZ2, WZ1 and the clock signal CK.

In some embodiments, the logic element LX12 is configured to receive each of the bit data XZ2, WZ1 and the clock signal CK and control the register RX12 to output the input data X2 to the multiplier M12 according to each of the bit data XZ2, WZ1 and the clock signal CK. The logic element LW12 is configured to receive each of the bit data XZ2, WZ1 and the clock signal CK and control the register RW12 to output the weight data W1 to the multiplier M12 according to each of the bit data XZ2, WZ1 and the clock signal CK. The logic element LY12 is configured to receive each of the bit data XZ2, WZ1 and the clock signal CK and control the register RX12 to output the output data Y12 to the adder A12 according to each of the bit data XZ2, WZ1 and the clock signal CK.

In some embodiments, the multiplier M12 is configured to receive each of the input data X2 and the weight data W1, multiply the input data X2 and the weight data W1 to generate output data MD12 and output the output data MD12 to the adder A12. The adder A12 is configured to receive each of the output data MD12 and Y12, add the output data MD12 and Y12 to generate output data AD12 and output the output data AD12 to the register RY12.

In some embodiments, in the processing element P21, the register R21X is configured to store input data X1 and output the input data X1 according to a clock signal CK. The register R21W is configured to store weight data W2 and output the weight data W2 according to the clock signal CK. The register RX21 is configured to store the input data X1 and output the input data X1 to a multiplier M21 according to each of bit data XZ1, WZ2 and the clock signal CK. The register RW21 is configured to store the weight data W2 and output the weight data W2 to the multiplier M21 according to each of the bit data XZ1, WZ2 and the clock signal CK. The register RXZ21 is configured to store the bit data XZ1 and output the bit data XZ1 according to the clock signal CK. The register RWZ21 is configured to store the bit data WZ2 and output the bit data WZ2 according to the clock signal CK. The register RY21 is configured to store each of output data Y21 and AD21 from the adder A21 and output each of the output data Y21 and AD21 to the adder A21 according to each of the bit data XZ1, WZ2 and the clock signal CK.

In some embodiments, the logic element LX21 is configured to receive each of the bit data XZ1, WZ2 and the clock signal CK and control the register RX21 to output the input data X1 to the multiplier M21 according to each of the bit data XZ1, WZ2 and the clock signal CK. The logic element LW21 is configured to receive each of the bit data XZ1, WZ2 and the clock signal CK and control the register RW21 to output the weight data W2 to the multiplier M21 according to each of the bit data XZ1, WZ2 and the clock signal CK. The logic element LY21 is configured to receive each of the bit data XZ1, WZ2 and the clock signal CK and control the register RX21 to output the output data Y21 to the adder A21 according to each of the bit data XZ1, WZ2 and the clock signal CK.

In some embodiments, the multiplier M21 is configured to receive each of the input data X1 and the weight data W2, multiply the input data X1 and the weight data W2 to generate output data MD21 and output the output data MD21 to the adder A21. The adder A21 is configured to receive each of the output data MD21 and Y21, add the output data MD21 and Y21 to generate output data AD21 and output the output data AD21 to the register RY21.

In some embodiments, in the processing element P22, the register R22X is configured to store input data X2 and output the input data X2 according to a clock signal CK. The register R22W is configured to store weight data W2 and output the weight data W2 according to the clock signal CK. The register RX22 is configured to store the input data X2 and output the input data X2 to a multiplier M22 according to each of bit data XZ2, WZ2 and the clock signal CK. The register RW22 is configured to store the weight data W2 and output the weight data W2 to the multiplier M22 according to each of the bit data XZ2, WZ2 and the clock signal CK. The register RXZ22 is configured to store the bit data XZ2 and output the bit data XZ2 according to the clock signal CK. The register RWZ22 is configured to store the bit data WZ2 and output the bit data WZ2 according to the clock signal CK. The register RY22 is configured to store each of output data Y22 and AD22 from the adder A22 and output each of the output data Y22 and AD22 to the adder A22 according to each of the bit data XZ2, WZ2 and the clock signal CK.

In some embodiments, the logic element LX22 is configured to receive each of the bit data XZ2, WZ2 and the clock signal CK and control the register RX22 to output the input data X2 to the multiplier M22 according to each of the bit data XZ2, WZ2 and the clock signal CK. The logic element LW22 is configured to receive each of the bit data XZ2, WZ2 and the clock signal CK and control the register RW22 to output the weight data W2 to the multiplier M22 according to each of the bit data XZ2, WZ2 and the clock signal CK. The logic element LY22 is configured to receive each of the bit data XZ2, WZ2 and the clock signal CK and control the register RX22 to output the output data Y22 to the adder A22 according to each of the bit data XZ2, WZ2 and the clock signal CK.

In some embodiments, the multiplier M22 is configured to receive each of the input data X2 and the weight data W2, multiply the input data X2 and the weight data W2 to generate output data MD22 and output the output data MD22 to the adder A22. The adder A22 is configured to receive each of the output data MD22 and Y22, add the output data MD22 and Y22 to generate output data AD22 and output the output data AD22 to the register RY22.

In some embodiments, each of the input data X2 and the weight data W2 is multiple-bit data, such as 32-bit data. In some embodiments, each of the input data X2 and the weight data W2 is data other than 32-bit data. In some embodiments, each of the bit data XZ2 and the bit data WZ2 is 1-bit data. In some embodiments, each of the bit data XZ2 and the bit data WZ2 is data other than 1-bit data. In some embodiments, the bit data XZ2 and the bit data WZ2 represent zero flags of the input data X2 and the weight data W2, respectively. Specifically, the bit data XZ2 indicates whether each of the bits of the input data X2 has a logic value 0, and the weight data W2 indicates whether each of the bits of the weight data W2 has a logic value 0. For example, in response to each of the bits of the input data X2 having the logic value 0, the bit data XZ2 has a logic value 1. In response to at least one of the bits of the input data X2 having the logic value 1, the bit data XZ2 has the logic value 0. In response to each of the bits of the weight data W2 having the logic value 0, the bit data WZ2 has the logic value 1. In response to at least one of the bits of the weight data W2 having the logic value 1, the bit data WZ2 has the logic value 0.

In some embodiments, each of the processing elements P11, P12 is arranged at a first row in a horizontal direction. Each of the processing elements P21, P22 is arranged at a second row in the horizontal direction. Each of the processing elements P11, P21 is arranged at a first column in a vertical direction. Each of the processing elements P12, P22 is arranged at a second column in the vertical direction. Other processing elements are arranged at different rows in the horizontal direction and different columns in the vertical direction.

In some embodiments, the systolic array 200 is configured to perform matrix multiplication. Specifically, during the matrix multiplication, the processing element P11 operates in a first clock period, and the processing elements P12 and P21 operates in a second clock period after the first clock period, and the processing element P22 operates in a third clock period after the second clock period. Each of the operations of the processing elements P11, P12, P21 and P22 correspond to the operations of the processing elements 100 in FIG. 1A. Therefore, similar descriptions of the operations of the processing elements P11, P12, P21 and P22 are omitted for brevity.

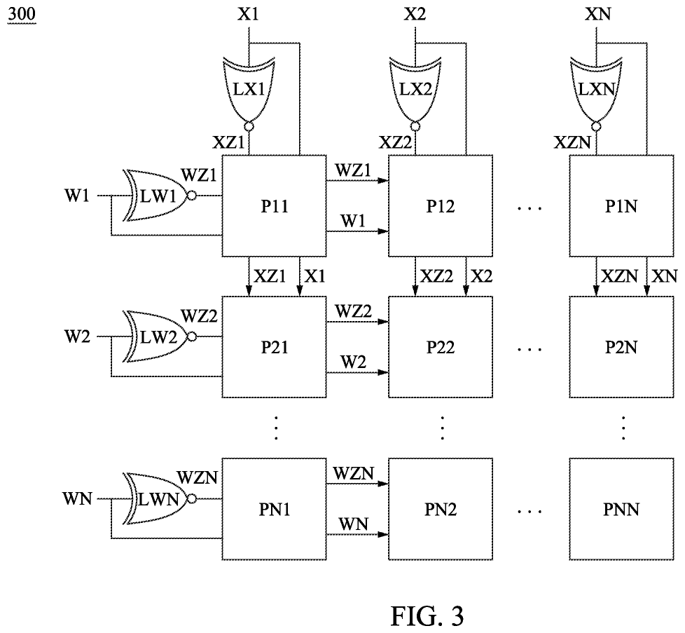

FIG. 3 is a schematic diagram of a systolic array 300, in accordance with some embodiments of the present disclosure. As illustratively shown in FIG. 3, the systolic array 300 includes processing elements P11, P12, . . . , PIN, P21, P22, . . . , P2N, . . . , PN1, PN2, . . . , PNN and logic elements LX1, LX2, . . . , LXN and LW1, LW2, . . . , LWN, where N is an integer more than 2. Referring to FIG. 1A, FIG. 2 and FIG. 3, the processing element 100 is an embodiment of each of the processing elements P11, P12, . . . , PIN, P21, . . . , P2N . . . , PN1, PN2, . . . , PNN in the systolic array 300. FIG. 3 follows a similar labeling convention to that of FIG. 1A and FIG. 2.

In some embodiments, each of the processing elements P11, P12, . . . , PIN is arranged at the first row in the horizontal direction. Each of the processing elements P21, P22, . . . , P2N is arranged at the second row in the horizontal direction. Each of the processing elements PN1, PN2, . . . , PNN is arranged at an Nth row in the horizontal direction. Each of the processing elements P11, P21, . . . , PN1 is arranged at the first column in the vertical direction. Each of the processing elements P12, P22, . . . , PN2 is arranged at the second column in the vertical direction. Each of the processing elements PIN, P2N, . . . , PNN is arranged at an Nth column in the vertical direction.

In some embodiments, the processing element P11 is configured to operate according to each of the input data X1, weight data W1, bit data XZ1 and WZ1, output the input data X1 and the bit data XZ1 to the processing element P21 and output the weight data W1 and the bit data WZ1 to the processing element P12. The processing element P12 is configured to operate according to each of the input data X2, bit data XZ2, weight data W1 and bit data WZ1, output the input data X2 and the bit data XZ2 to the processing element P22 and output the weight data W1 and the bit data WZ1 to the processing element P13. The processing element PIN is configured to operate according to each of the input data XN, bit data XZN, weight data W1 and bit data WZ1 and output the input data XN and the bit data XZN to the processing element P2N.

In some embodiments, the processing element P21 is configured to operate according to each of the input data X1, bit data XZ1, weight data W2 and bit data WZ2, output the input data X1 and the bit data XZ1 to the processing element P31 and output the weight data W2 and the bit data WZ2 to the processing element P22. The processing element P22 is configured to operate according to each of the input data X2, bit data XZ2, weight data W2 and bit data WZ2, output the input data X2 and the bit data XZ2 to the processing element P32 and output the weight data W2 and the bit data WZ2 to the processing element P23. The processing element P2N is configured to operate according to each of the input data XN, bit data XZN, weight data W2 and bit data WZ2 and output the input data XN and the bit data XZN to the processing element P3N.

In some embodiments, the processing element PN1 is configured to operate according to each of the input data X1, bit data XZ1, weight data WN and bit data WZN and output the weight data WN and the bit data WZN to the processing element PN2. The processing element PN2 is configured to operate according to each of the input data X2, bit data XZ2, weight data WN and bit data WZN and output the input data XN and the bit data XZN to the processing element PN3. The processing element PNN is configured to operate according to each of the input data XN, bit data XZN, weight data WN and bit data WZN.

During the matrix multiplication of the systolic array 300, during a first clock period, the processing element P11 performs the operation described in FIG. 1A. During a second clock period after the first clock period, each of the processing elements P12 and P21 performs the operation described in FIG. 1A. During a third clock period after the second clock period, each of the processing elements P13, P22 and P31 performs the operation described in FIG. 1A. During an Nth clock period after an (N−1)th clock period, each of the processing elements P1N, P2(N−1), P3(N−2), . . . , P(N−1)2 and PN1 performs the operation described in FIG. 1A. During an (N+1)th clock period after an Nth clock period, each of the processing elements P2N, P3(N−1), P4(N−2), . . . , P(N−1)3 and PN2 performs the operation described in FIG. 1A. During an (2N−1)th clock period after an (2N−2)th clock period, the processing elements PNN performs the operation described in FIG. 1A.

In some embodiments, the processing elements P11, P12-P1N are coupled to the logic elements LX1, LX2-LXN, respectively, and the processing elements P11, P21-PN1 are coupled to the logic elements LW1-LWN, respectively. In some embodiments, each of the logic elements LX1-LXN and LW1-LWN is implemented as a NOR gate. In some embodiments, each of the logic elements LX1-LXN and LW1-LWN is implemented as other logic elements which are logically equivalent to a NOR gate.

In some embodiments, the logic element LX1 is configured to receive the input data X1, generate the bit data XZ1 according to the input data X1 and output the bit data XZ1 to the processing element P11. The logic element LX2 is configured to receive the input data X2, generate the bit data XZ2 according to the input data X2 and output the bit data XZ2 to the processing element P12. The logic element LXN is configured to receive the input data XN, generate the bit data XZN according to the input data XN and output the bit data XZN to the processing element P1N. The logic element LW1 is configured to receive the weight data W1, generate the bit data WZ1 according to the weight data W1 and output the bit data WZ1 to the processing element P11. The logic element LW2 is configured to receive the weight data W2, generate the bit data WZ2 according to the weight data W2 and output the bit data WZ2 to the processing element P21. The logic element LWN is configured to receive the weight data WN, generate the bit data WZN according to the weight data WN and output the bit data WZN to the processing element P1N.

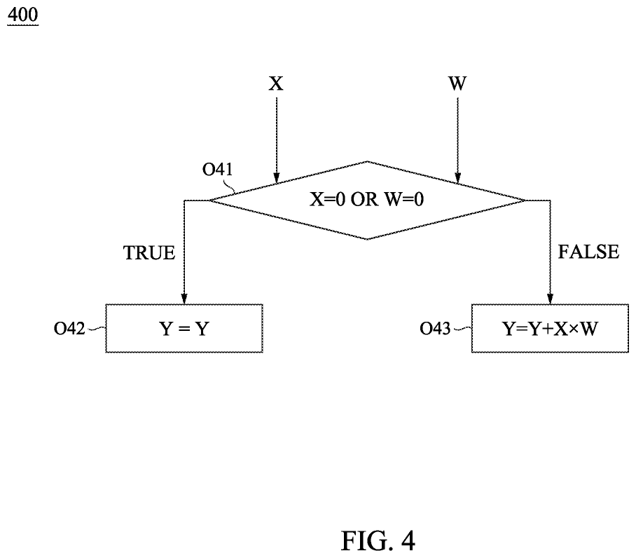

FIG. 4 is a flowchart diagram of a method 400 operating at least one of the processing elements 100, P11, P12-P1N, P21, P22-P2N, PN1, PN2-PNN shown in FIG. 1A, FIG. 2 and FIG. 3, in accordance with some embodiments of the present disclosure. As illustratively shown in FIG. 4, the method 400 includes operations O41-O43.

During the operation O41, each of the input data X and the weight data W is inputted to a processing element, and the processing element determines whether at least one of each of the bits of the input data X and each of the bits of the weight data W has the logic value 0. If at least one of each of the bits of the input data X and each of the bits of the weight data W has the logic value 0, the operation O42 is performed after the operation O41. If at least one of the bits of the input data X and at least one of the bits of the weight data W has the logic value 1, the operation O43 is performed after the operation O41. For example, each of the input data X1 and the weight data W1 is inputted to the registers R11X, R11W, RX11 and RW11 in the processing element 100, and the processing element 100 determines whether at least one of the bit data XZ1 and WZ1 has the logic value 1 by the logic elements LX11 and LW11. In some embodiments, the input data X corresponds to the input data X1, X2, . . . , XN and the weight data W corresponds to the weight data W1, W2, . . . , WN in FIG. 1A, FIG. 2 and FIG. 3.

During the operation O42, the output data Y in the processing element does not change or update. For example, in response to each of the registers RX11, RW11 and RY11 being clock gated by the logic elements LX11, LW11 and LY11, the output data Y11 stored in the register RY11 in the processing element 100 does not change or update. In some embodiments, the output data Y corresponds to the output data Y11, Y12, . . . , Y1N, Y21, Y22, . . . , Y2N, YN1, YN2, . . . , YNN in FIG. 1A, FIG. 2 and FIG. 3.

During the operation O43, the output data Y in the processing element changes or updates from output data Y to input data X multiplied by weight data W and added by output data Y. For example, in the processing element 100, in response to the multiplier M11 receiving the input data X1 and the weight data W1, the multiplier M11 multiplies the input data X1 by the weight data W1 to generate the output data MD11 and outputs the output data MD11 to the adder A11. The adder A11 adds the output data MD11 and Y11 to generate the output data AD11 and outputs the output data AD11 to the register Y11.

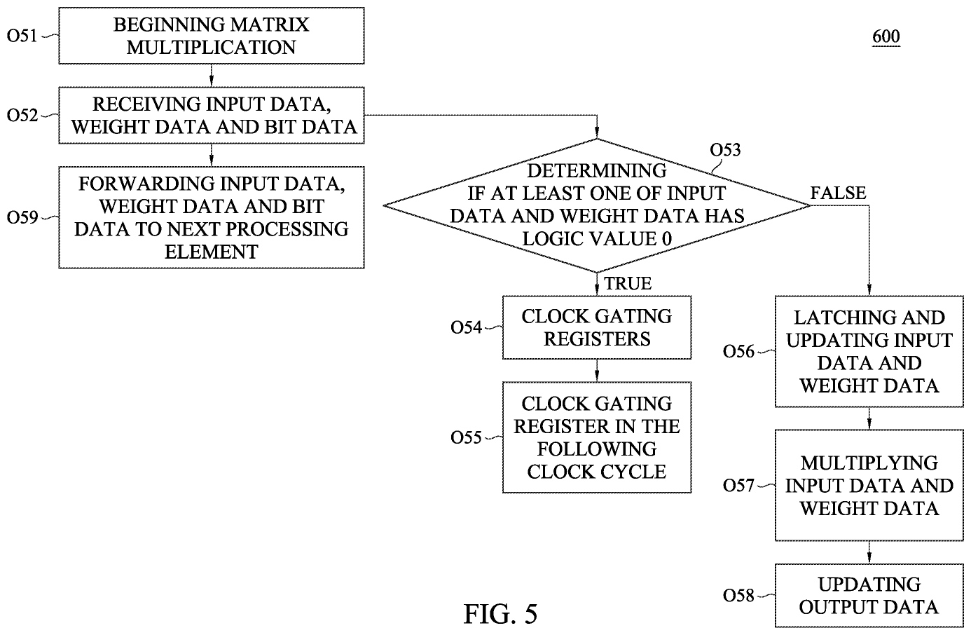

FIG. 5 is a flowchart diagram of a method 500 operating at least one of the processing elements 100, P11, P12-P1N, P21, P22-P2N, PN1, PN2-PNN shown in FIG. 1A, FIG. 2 and FIG. 3, in accordance with some embodiments of the present disclosure. As illustratively shown in FIG. 5, the method 500 includes operations O51-O59.

During the operation O51, a systolic array begins a matrix multiplication. For example, the systolic array 200 begins the matrix multiplication.

During the operation O52, a processing element in the systolic array receives input data, weight data and bit data. For example, the processing element P11 in the systolic array 200 receives the input data X1, the weight data W1 and the bit data XZ1 and WZ1.

During the operation O53, the processing element determines whether at least one of the data value of the input data and the weight data is equal to the logic value 0. When at least one of the data value of the input data and the weight data is equal to the logic value 0, the operation O54 is performed after the operation O53. When each of the data value of the input data and the weight data is not equal to the logic value 0, the operation O56 is performed after the operation O53. For example, the processing element P11 determines whether at least one of the data value of the input data X1 and the weight data W1 is equal to the logic value 0. When at least one of the bit value of the bit data XZ1 and WZ1 is equal to the logic value 1, the operation O54 is performed after the operation O53. When each of the bit value of the bit data XZ1 and WZ1 is equal to the logic value 0, the operation O56 is performed after the operation O53.

During the operation O54, the registers are clock gated. For example, in the first clock cycle, the registers RX11 and RW11 are clock gated and does not output the input data X1 and the weight data W1 to the multiplier M11, respectively.

During the operation O55, the register is clock gated in the following clock cycle. For example, in the second clock cycle after the first clock cycle, the registers RY11 is clock gated and does not output the output data Y11 to the adder A11.

During the operation O56, the processing element latches an updates the input data and the weight data. For example, in the processing element P11, the registers RX11 and RW11 store the input data X1 and the weight data W1, respectively, and output the input data X1 and the weight data W1 to the multiplier M11, respectively.

During the operation O57, the processing element multiplies the input data and the weight data. For example, in the processing element P11, the multiplier M11 multiplies the input data X1 and the weight data W1 to generate the output data MD11.

During the operation O58, the processing element updates the output data. For example, in the processing element P11, the adder A11 adds the output data MD11 from the multiplier M11 and the output data Y11 from the register RY11 to generate the output data AD11 and outputs the output data AD11 to the register RY11.

During the operation O59, the processing element forwards the input data, weight data and bit data to next processing element. For example, the processing element P11 forwards the input data X1 and the bit data XZ1 to the processing element P21, and forwards the weight data W1 and the bit data WZ1 to the processing element P12.

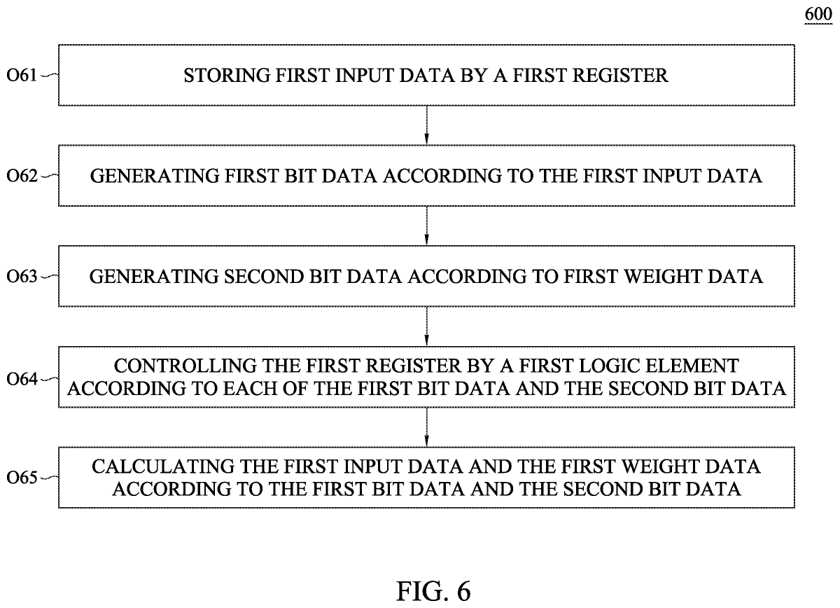

FIG. 6 is a flowchart diagram of a method 600 operating at least one of the processing elements 100, P11, P12-P1N, P21, P22-P2N, PN1, PN2-PNN shown in FIG. 1A, FIG. 2 and FIG. 3, in accordance with some embodiments of the present disclosure. As illustratively shown in FIG. 6, the method 600 includes operations O61-O65.

During the operation O61, a first register stores first input data. For example, the register RX11 stores the input data X1.

During the operation O62, first bit data is generated according to the first input data. For example, the bit data XZ1 is generated according to the input data X1.

During the operation O63, second bit data is generated according to the first weight data. For example, the bit data WZ1 is generated according to the weight data W1.

During the operation O64, a first logic element controls the first register according to each of the first bit data and the second bit data. For example, the logic element LX11 controls the register RX11 according to each of the bit data XZ1 and the bit data WZ1.

During the operation O65, the first input data and the first weight data are calculated according to the first bit data and the second bit data. For example, the input data X1 and the weight data W1 are calculated according to the bit data XZ1 and the bit data WZ1.

In some approaches, some semiconductor devices include systolic arrays to perform matrix multiplication by streaming input data to arrays of processing elements. Some input data contain a high number of O-valued elements. However, once the data is already in the input stream, operations of the systolic arrays on each element of the data are performed. As a result, the power consumption of the semiconductor device is high.

Compared to above approaches, in some embodiments of present disclosure, the registers RX11, RW11 and RY11 are clock gated or deactivated by the logic elements LX11, LW11 and LY11, respectively, when at least one of the bit data XZ1 and WZ1 has the logic value 1, such that the output data of the processing element 100 is not updated when at least one of the input data X1 and the weight data W1 has the logic value 0. As a result, the power consumption is reduced and the power efficiency is improved.

Also disclosed is a device. The device includes a first register, a second register, a third register and a first logic element. The first register is configured to store first input data. The second register is configured to store first weight data. The third register is configured to output first output data according to each of the first input data and the first weight data. The first logic element is configured to control the first register according to each of first bit data and second bit data. The first bit data and the second bit data correspond to the first input data and the first weight data, respectively.

Also disclosed is a device. The device includes a first processing element, a second logic element and a third logic element. The first processing element comprises a first register and a first logic element. The first register is configured to output the first output data. The first logic element is configured to control the first register according to each of the first bit data and the second bit data. The second logic element is configured to generate the first bit data according to the first input data. The third logic element is configured to generate the second bit data according to the first weight data.

Also disclosed is a method. The method includes: storing first input data by a first register; generating first bit data according to the first input data; generating second bit data according to first weight data; controlling the first register by a first logic element according to each of the first bit data and the second bit data; and calculating the first input data and the first weight data according to the first bit data and the second bit data.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A device, comprising:
a first register configured to store first input data;
a second register configured to store first weight data;
a third register configured to output first output data according to each of the first input data and the first weight data; and
a first logic element configured to control the first register according to each of first bit data and second bit data,
wherein the first bit data and the second bit data correspond to the first input data and the first weight data, respectively.

2. The device of claim 1, further comprising:
a second logic element configured to control the second register according to each of the first bit data and the second bit data.

3. The device of claim 2, further comprising:
a fourth register configured to store the first bit data;
a fifth register configured to store the second bit data; and
a third logic element configured to control the third register according to each of the first bit data and the second bit data.

4. The device of claim 3, wherein
when at least one of the first input data and the first weight data has a first data value, the first register is deactivated.

5. The device of claim 4, wherein
when each of the first input data and the first weight data has a second data value different from the first data value, the first register is activated.

6. The device of claim 3, wherein
the first logic element is further configured to control the first register according to a clock signal,
the second logic element is further configured to control the second register according to the clock signal, and
the third logic element is further configured to control the third register according to the clock signal.

7. The device of claim 6, wherein
when the first bit data has a first logic value, the first input data has a first data value equal to a second logic value different from the first logic value, and
when the first bit data has the second logic value, the first input data has a second data value different from the second logic value.

8. The device of claim 6, wherein
when the second bit data has a first logic value, the first weight data has a first data value equal to a second logic value different from the first logic value, and
when the first bit data has the second logic value, the first input data has a second data value different from the second logic value.

9. The device of claim 6, wherein
when at least one of the first input data and the first weight data has a first data value, the third register is deactivated, and
when each of the first input data and the first weight data has a second data value different from the first data value, the third register is activated.

10. A device, comprising:
a first processing element configured to store first output data according to each of first input data, first weight data, first bit data and second bit data, the first processing element comprising:
a first register configured to output the first output data; and
a first logic element configured to control the first register according to each of the first bit data and the second bit data;
a second logic element configured to generate the first bit data according to the first input data; and
a third logic element configured to generate the second bit data according to the first weight data.

11. The device of claim 10, further comprising:
a second processing element configured to store second output data according to each of second input data, the first weight data, third bit data and the second bit data; and
a fourth logic element configured to generate the third bit data according to the second input data.

12. The device of claim 10, further comprising:
a second processing element configured to store second output data according to each of second weight data, the first input data, third bit data and the first bit data; and
a fourth logic element configured to generate the third bit data according to the second weight data.

13. The device of claim 10, wherein
when at least one of the first bit data and the second bit data has a first logic value, the first register is deactivated, and
when each of the first bit data and the second bit data has a second logic value different from the first logic value, the first register is activated.

14. The device of claim 10, wherein the first processing element further comprises:
a second register configured to output the first input data; and
a fourth logic element configured to control the second register according to each of the first bit data and the second bit data.

15. The device of claim 14, wherein the first processing element further comprises:
when the first bit data has a first logic value, the first input data has a first data value equal to a second logic value different from the first logic value, and
when the first bit data has the second logic value, the first input data has a second data value different from the second logic value.

16. The device of claim 15, wherein
when at least one of the first bit data and the second bit data has the first logic value, the second register is deactivated, and
when each of the first bit data and the second bit data has the second logic value, the second register is activated.

17. A method, comprising:
storing first input data by a first register;
generating first bit data according to the first input data;
generating second bit data according to first weight data;
controlling the first register by a first logic element according to each of the first bit data and the second bit data; and
calculating the first input data and the first weight data according to the first bit data and the second bit data.

18. The method of claim 17, further comprising:
storing the first weight data by a second register; and
controlling the second register by a second logic element according to each of the first bit data and the second bit data.

19. The method of claim 18, further comprising:
when at least one of the first bit data and the second bit data has a first logic value, deactivating each of the first register and the second register; and
when each of the first bit data and the second bit data has a second logic value different from the first logic value, activating each of the first register and the second register.

20. The method of claim 19, wherein
when the first bit data has the first logic value, the first input data has a first data value equal to the second logic value, and
when the first bit data has the second logic value, the first input data has a second data value different from the second logic value.
